(19) United States
(12) Patent Application Publication
(10) Pub. No.: US 2025/0075361 A1
(43) Pub. Date: Mar. 6, 2025

(54) ELECTRIC WIRES AND CABLES FOR SPACE APPLICATIONS

(71) Applicant: AXON CABLE, Montmirail (FR)

(72) Inventors: Ning YU, Montmirail (FR); Aurélie M. DE JESUS, Montmirail (FR)

(21) Appl. No.: 18/554,770

(22) PCT Filed: Apr. 11, 2022
(86) PCT No.: PCT/FR2022/050678

§ 371 Date: Oct. 10, 2023

(30) Foreign Application Priority Data
Apr. 13, 2021 (FR) FR2103805

(51) Int. Cl. C25D 7/06; C25D 3/46; C25D 5/18; H01B 1/02; H01B 7/17

(52) U.S. Cl. CPC C25D 7/0607; C25D 3/46; C25D 5/18; H01B 1/02; H01B 7/17

(57) ABSTRACT

The present invention relates to a process for manufacturing a silver-plated copper or a copper alloy blank wire, having a silver layer thickness of 1.5 μm to 15 μm, comprising the step of electrolytically depositing silver on the copper or copper alloy blank wire, said electrolytic deposition being performed at a pulsating current with reversal in a silver-plating bath under particular electrolytic conditions. It also relates to the silver-plated copper or copper alloy blank wire obtainable by said process, a process for manufacturing a silver-plated copper or copper alloy strand, the strand obtainable by said process, a silver-plated conductor and an electromagnetic shielding layer comprising the silver-plated strand, an electric wire comprising the silver-plated conductor and an electric cable comprising the electric wire and uses thereof.

### TECHNICAL FIELD

The present invention relates to electric wires and cables containing a copper or copper alloy conductor coated with a silver layer and having enhanced resistance to oxidation and corrosion. In particular, these wires and cables can be used for space applications.

### PRIOR ART

The ESCC (European Space Components Coordination) standard No 3901 (May 2013) defines a family of electric wires and cables for space applications.

Being composed of copper or copper alloy conductors coated with a silver layer, hereinafter SPC (Silver-plated Copper) conductors, either in the central core or in electromagnetic shielding, these wires and cables are hereinafter called SPC wires and SPC cables respectively.

In order to classify the electrical conductors according to their section, an AWG (American Wire Gauge) standardization protocol is established in standard ASTM B258 (April 2002). This standard explicitly defines how to construct a conductor in terms of the number of strands. The SPC conductors presented in the present invention are also governed by said standard.

Said standard ESCC-3901 also stipulates a minimum silver coating thickness of 2 μm on all SPC conductors, unlike the majority of applications where SPC conductors are coated with a minimum of 1 μm silver according to standard ASTM B298 (December 2017). The reason for this doubling of the silver thickness is related to the requirements of the space application where the protection of electrical and electronic systems against corrosion is of extreme importance.

This is the reason why said standard ESCC-3901 imposes a control test called Antony & Brown control test, hereinafter A&B test, on the SPC conductors contained in the SPC wires and cables in order to guarantee the quality of the silver coating. Being the subject of standard ECSS-Q-ST-70-20C (July 2008), this A&B test is basically a corrosion test to determine the level of resistance of SPC conductors to corrosion called “red plague”, which can be interpreted as the oxidation of copper. As described in detail in said standard, in this test a sample of 20 mm insulation stripped SPC conductor is placed in a container in which an oxygen-rich atmosphere prevails using a continuous flow of oxygen. The assembly is subjected to a temperature of 58° C. for 240 hours or 10 whole days. After this test, a microscopic inspection is carried out with magnification of ×20 and the oxidation state of the sample is determined by assigning a code which ranges over 6 levels, as explained in table 1 below.

TABLE 1

| Code | Surface state | Level of oxidation |
|---|---|---|
| 0 | No defect | |
| 1 | Minor defect | One point on 1-2 two adjacent strands |
| 2 | Minor defect | Weak corrosion on 2-8 adjacent strands at one |
| | | location along the length of the sample. |
| 3 | Minor defect | Weak corrosion on 2-8 adjacent strands at few |
| | | locations along the length of the sample. |
| 4 | Major defect | Moderate corrosion on 2-10 adjacent strands at |
| | | several locations along the length of the sample. |
| 5 | Major defect | Severe corrosion affecting more than 50% of |
| | | strands over the length of the sample. |

Said standard strictly penalizes any sample of codes 4 and 5, that is to say having a major defect of corrosion by oxidation of the copper or copper alloy.

Given the duration of the A&B test, in practice, to be able to carry out quality control during the manufacture of SPC conductors, use is made of another test called Polysulfide, which is shorter in time. Being the subject of standard ISO 10308 (January 2006), the Polysulfide test consists in immersing an SPC conductor in a sodium polysulfide solution for 30 seconds, then rinsing and drying it. A binocular examination is then carried out with magnification of ×10. It is considered that the test is good when no point of corrosion on the conductor is observed (resistance to oxidation).

The manufacture of SPC wires and cables typically involves several steps.

The first step is to perform an electroplating (or electrolytic deposition) of silver, more often called silver-plating, on round wires called copper or copper alloy blanks. The operation is continuous, sometimes called “reel to reel”. More precisely, several wires as a cathode run through an electrolytic silver-plating bath in which a pure silver anode is installed. During the operation an electric generator delivers a direct current between the cathode and the anode. This current generates an electrolysis allowing simultaneously to dissolve, on the one hand, the silver anode and, on the other hand, to deposit a silver coating on the moving wires.

The second step is called drawing, which consists in cold reducing the diameter of a silver blank wire by mechanical force. Use is made of a machine called drawing machine containing a set of 5 to 30 dies depending on the need, the diameters of which gradually decrease. The silver wires after drawing are called SPC strands, which will be used to make either an SPC conductive stranded wire or an SPC electromagnetic 2s shield (which is braided or helical).

The third step called stranding is the implementation of an SPC conductor itself. Using a machine called “strander”, a precise number of SPC strands are assembled according to one of the construction modes defined in standard ASTM B258.

The fourth step, called insulation, consists in placing a layer of dielectric around an SPC conductive core to obtain an SPC electric wire. The dielectric materials used here are generally based on polytetrafluoroethylene (PTFE), ethylene tetrafluoroethylene (ETFE) and polyimide, all qualified by standard ESCC3901. The operation is carried out either by extrusion for PTFE and ETFE, or by taping for PTFE and polyimide in the form of a tape. In some cases, these SPC wires are coated with a thin finish layer, sometimes called coating, based on polyimide in order to provide them with additional functions, for example coloring. The implementation of this solid finish layer is generally carried out from a polyimide liquid using one or more passages in an oven of 250° C. to 500° C. depending on the need.

The fifth step, called assembly, puts several (from 2 to 4) electric wires into a twisted bundle by stranding in order to obtain a subset of SPC electric wires.

The sixth step called braiding or wrapping consists in implementing a layer of SPC strands around a subset of electric wires. This braiding or wrapping layer, often called shielding layer, forms a protective screen against electromagnetic disturbances.

The seventh step, called sheathing, allows to finalize the manufacture of the SPC cable by placing a protective sheath around a subset of shielded wires. Sheath materials are PTFE, ETFE, perfluoroalkoxy (PFA) and polyimide, all qualified to standard ESCC3901. The operation is carried out either by extrusion for PTFE, PFA and ETFE, or by taping for PTFE and Polyimide in the form of a tape.

All the manufacturing steps can be summarized below:
E1: Silver-plating on copper or copper alloy blank wires=>silver-plated blank wires.
E2: Drawing a silver-plated wire=>SPC strand.
E3: Assembling SPC strands=>SPC conductor.
E4: Taping or extruding a dielectric (ETFE, PTFE, polyimide, . . . ) on SPC conductor=>SPC electric wire.
E5: Assembling several electric wires=>subset.
E6: Braiding or wrapping SPC strands on subset=>shielded subset
E7: Sheathing the shielded subset=>SPC cable.

It is known that these manufacturing steps involving thermal and mechanical stresses can have an impact on the performance of the silver coating in the A&B test, in particular when these manufacturing steps involve traction, torsion, heating and other actions. The greater the amplitudes of these operating parameters (time, force, pressure, temperature, . . . ), the more advanced is the deterioration of the performance of the silver coating on the SPC conductor.

The inventors have surprisingly discovered that it is possible to overcome these degradations by modifying step E1 of this process, that is to say by using an electrolytic deposition of silver by a pulsating current with reversal (PCR) instead of direct current (DC). Indeed, unlike the electrolytic deposition at DC where a constant electrolytic current is delivered by an electric generator throughout the silver-plating, that at PCR uses an electrolytic current which is discontinuous and modulated in the form of a series of cathodic pulses at a certain given frequency, each cathodic pulse being followed by an anodic pulse. The inventors have thus noticed that electroplating at PCR, when it is well mastered and therefore under precise conditions, allows to best optimize the nucleation and the growth of the electrolytic deposition and consequently to improve the performance of SPC conductor in A&B test. It is thus even possible to reduce the thickness of the silver layer deposited on the SPC conductor to only 1 μm thanks to the process according to the invention while allowing said SPC conductor to have better resistance in the A&B test than the conventional SPC conductors (whose silver layer is obtained by DC electrolytic deposition) having a deposited silver layer thickness of 2 μm. Indeed the inventors have noticed that the silver coating produced at PCR has a better state of crystallization, which is more homogeneous and denser.

### DISCLOSURE OF THE INVENTION

The present invention therefore relates to a process for manufacturing a silver-plated copper or copper alloy blank wire, having a silver layer thickness of 1.5 μm to 15 μm, advantageously of 2 μm to 10 μm, comprising the step of electrolytically depositing silver (electroplating) on the copper or copper alloy blank wire, said electrolytic deposition being performed at a pulsating current with reversal (PCR) in a silver-plating bath comprising from 40 to 70 g/l, in particular from 40 to 65 g/l, more particularly from 45 to 60 g/l, of silver cyanide (AgCN) and from 90 g/l to 150 g/l, in particular from 90 to 140 g/l, more particularly from 100 to 130 g/l, of potassium cyanide (KCN), the electrolytic conditions being the following:
average current density Jm comprised between 1.5 A/dm² and 15 A/dm², advantageously between 1.78 A/dm² and 10 A/dm², in particular between 1.78 A/dm² and 5 A/dm²;
pulse frequency f comprised between 0.8 Hz and 1.6 Hz, advantageously between 0.8 Hz and 1.4 Hz, in particular 1 Hz;
duty cycle Q comprised between 50 and 80%, advantageously between 55% and 65%;
current density of the cathode peak Jc comprised between 3 A/dm² and 11 A/dm², advantageously between 5 A/dm² and 10 A/dm², more particularly between 3 A/dm² and 8 A/dm², advantageously between 5 A/dm² and 7 A/dm²;
current density of the anode peak Ja comprised between 1 A/dm² and 5 A/dm², advantageously between 1.28 A/dm² and 4.2 A/dm², more particularly between 1.28 and 3.1 A/dm² even more particularly between 1.28 and 2.16 A/dm²;
time of maintaining the cathodic pulse Tc comprised between 0.2 s and 0.8 s, advantageously between 0.55 s and 0.65 s and
time of maintaining the anode pulse Ta comprised between 0.06 s and 0.5 s, advantageously between 0.35 s and 0.45 s.

Within the meaning of the present invention, the terms “comprised between . . . and . . . ” or “comprising from . . . to . . . » include the values of the limits.

Within the meaning of the present invention, the term “silver-plated copper or copper alloy blank wire” means any round wire, not usable directly in a conductor, made of copper or copper alloy, coated with a silver layer. In particular, the diameter of the blank wire is comprised between 0.1 and 1.5 mm, in particular between 1 mm and 0.2 mm. The copper alloy of the blank wire according to the invention can be any usable copper alloy in the blank wires such as a Cu—Be—Ni alloy, the composition of which in mass % is for example Be: 0.2-0.6%, Ni: 1.4-2.2%, Cu: the balance or a Cu—Cr—Zr alloy, the composition of which in mass % is for example Cr: 0.10-1.05%, Zr: 0.01-0.105%, Cu: the balance. Within the meaning of the present invention, the term “electrolytically depositing silver at a pulsating current with reversal” or “electrolytically depositing silver at PCR” means any electrolytic deposition of silver or electroplating of silver or silver-plating in which is used a discontinuous and modulated electrolytic current in the form of a series of cathodic pulses at a certain given frequency, each cathodic pulse being followed by an anodic pulse, preceded or not and/or followed or not by a rest period, advantageously having no rest period. This PCR mode is schematically shown in FIG. 1 (current density J in A/dm² as a function of time in s) in which T represents the period (in s), Tc represents the time of maintaining the cathodic pulse (in s), Ta represents the time of maintaining the anodic pulse (in s), Tr represents the rest time (in s), Jc represents the current density of the cathodic peak (in A/dm²), Ja represents the current density of the anodic peak (in A/dm²), Jm represents the average current density over the period T (in A/dm²).

The relationship between these different parameters corresponds to the following formula:

$$Jm = \frac{( Jc Tc ) - ( Ja Ta )}{2 Tr + Tc + Ta} \text{?}$$

$$\text{?} \text{indicates text missing or illegible when filed}$$

Moreover, the duty cycle Q (in %) is defined as the ratio of the portion of the time of the cathodic pulse Tc over the period T, according to the following formula:

$$Q = \frac{Tc}{2 Tr + Tc + Ta}$$

and the frequency of the pulses f in Hz, according to the following formula: f=1/T

The process according to the invention therefore allows to cover the blank wire with a continuous silver layer with a thickness of 1.5 μm to 15 μm, advantageously of 2 μm to 10 μm.

In an advantageous embodiment, the process is a continuous process. Thus, several blank wires, in particular at least 3 blank wires, more advantageously 5 blank wires, as cathode, run through the electrolytic silver-plating bath in which a pure silver anode is installed. During operation the electric generator, for example of the Harlor PE86CB-20-10-50S type, delivers a current between the cathode and the anode which is discontinuous and modulated in the form of a series of cathode pulses at a certain given frequency, each cathodic pulse being followed by an anodic pulse. This current generates an electrolysis allowing simultaneously to dissolve on the one hand the silver anode and on the other hand to deposit a silver coating on the running blank wires.

Advantageously, the electrolytic silver-plating bath is an aqueous electrolytic bath comprising silver cyanide and potassium cyanide. It can also comprise additives such as a brightener additive, advantageously at a concentration comprised between 10 ml/l and 50 ml/l, in particular 19 ml/l. The electrolytic bath can be a high-speed bath, advantageously operating from 3 A/dm².

The running speed of the threads can be 4.0 m/min.

The present invention further relates to a silver-plated copper or a copper alloy blank wire, having a silver layer thickness of 1.5 μm to 15 μm, advantageously of 2 μm to 10 μm, obtainable by the process according to the invention. It is possible to distinguish this silver blank wire from a conventional silver blank wire (obtained by electrolytically depositing silver at direct current) by using very advanced analysis means such as transmission electron microscopy TEM combined with grazing incidence X-ray diffraction. Indeed, the silver coating produced at PCR has a better state of crystallization, is more homogeneous and denser. The blank wire is in particular as described above.

Advantageously, the silver-plated copper or copper alloy blank wire according to the invention does not have any defects or only minor defects in the A&B test according to standard ECSS-Q-ST-70-20C (July 2008), in particular it has the code 0, 1, 2 or 3, more particularly the code 0, 1 or 2, even more particularly the code 0 or 1, even more particularly the code 0, in the A&B test according to standard ECSS-Q-ST-70-20C.

Advantageously, the silver-plated copper or copper alloy blank wire according to the invention does not have any defect in the polysulfide test according to standard ISO 10308 (January 2006), in particular in the more severe polysulfide test in which the time of quenching the wire in the sodium polysulfide solution was lengthened to 20 minutes.

Advantageously, the silver-plated copper or copper alloy blank wire according to the invention has good adhesion at the adhesion test which consists in winding the wire around itself 5 to 6 times and then examining it under binocular observation at a magnification of ×10. It is considered that the adhesion is good only if no crack or detachment on the silver coating is detected.

In particular, the diameter of the silver blank wire according to the invention is comprised between 0.1 mm and 1.5 mm.

The present invention further relates to a process for manufacturing a silver-plated copper or copper alloy strand, having a silver layer thickness of 1 μm to 1.5 μm, comprising the step of drawing the silver-plated copper or copper alloy blank wire according to the invention.

The drawing step according to the invention allows to reduce the diameter of the silver blank wire according to the invention. Advantageously, this step is carried out cold, advantageously at room temperature, in particular by mechanical force, for example using a machine called drawing machine which can contain a set of 5 to 30 dies depending on the need, advantageously by reducing the diameter of the blank wire of at least 6.6% (ratio between the final diameter of the strand and the diameter of the blank wire), advantageously so as to obtain a strand with a diameter comprised between 0.063 mm and 0.254 mm.

The present invention further relates to a silver-plated copper or copper alloy strand, having a silver layer thickness of 1 μm to 1.5 μm, in particular of 1 μm to 1.4 μm, more particularly of 1.1 μm to 1.3 μm. Advantageously, the silver-plated strand according to the invention has a diameter comprised between 0.063 mm and 0.254 mm, in particular between 0.079 mm and 0.2 mm, more particularly between 0.1 mm and 0.2 mm.

It is possible to distinguish this silver-plated strand (or SPC strand) from a conventional silver-plated strand (whose silver layer was obtained by electrolytically depositing silver at direct current) by using very advanced analysis means such as transmission electron microscopy TEM (transmission electron microscopy) combined with grazing incidence X-ray diffraction. Indeed, the silver coating produced at PCR has a better state of crystallization, is more homogeneous and denser.

Advantageously, the silver-plated strand according to the invention does not have any defects or only minor defects in the A&B test according to standard ECSS-Q-ST-70-20C (July 2008), in particular it has the code 0, 1, 2 or 3, more particularly the code 0, 1 or 2, even more particularly the code 0 or 1, even more particularly the code 0, in the A&B test according to standard ECSS-Q-ST-70-20C.

Advantageously, the silver-plated strand according to the invention does not have any defect in the polysulfide test according to standard ISO 10308 (January 2006), in particular in the more severe polysulfide test in which the time of quenching the strand in the sodium polysulfide solution was lengthened to 20 minutes.

Advantageously, the silver-plated strand according to the invention has good adhesion at the adhesion test which consists in winding the strand around itself 5 to 6 times and then examining it under binocular observation at a magnification of ×10. It is considered that the adhesion is good only if no crack or detachment on the silver coating is detected.

The present invention further relates to a silver-plated conductor (or SPC conductor) comprising at least one silver-plated strand according to the invention, advantageously all the strands of which are according to the invention. It is in particular an electrical conductor.

Advantageously, the conductor according to the invention is a single-strand or multi-strand conductor, advantageously a multi-strand conductor.

In a particular embodiment, the conductor is multi-stranded. It can for example contain 7, 19, 27, 37, 45, and 61 silver-plated strands according to the invention and 7*7 silver-plated strands according to the invention. Advantageously, the conductor according to the present invention contains 19 or 37 silver-plated strands according to the invention, even more advantageously 19 silver-plated strands according to the invention. Depending on the number of silver-plated strands according to the invention, the assemblies according to standard ASTM B258 (April 2002) can be used such as for example twists, concentrics (in particular 19, 61 or 37 silver-plated strands according to the invention), Equilay, semi-concentrics, Unilay (in particular 19 silver-plated strands according to the invention) or Ropelay (in particular for 7*7 silver-plated strands according to the invention). Advantageously, the electrical conductor contains 19 silver-plated strands according to the invention assembled concentrically. Advantageously, the conductor according to the invention is obtained by stranding (or assembling) the silver-plated strands according to the invention.

Advantageously, the silver-plated conductor (or SPC conductor) according to the invention does not have any defect or only minor defects in the A&B test according to standard ECSS-Q-ST-70-20C (July 2008), in particular it has the code 0, 1, 2 or 3, more particularly the code 1 or 2, even more particularly the code 1, in the A&B test according to standard ECSS-Q-ST-70-20C.

Advantageously, the silver-plated conductor according to the invention does not have any defect in the polysulfide test according to standard ISO 10308 (January 2006), in particular in the more severe polysulfide test in which the quenching time of the conductor in the sodium polysulfide solution was lengthened to 20 minutes.

Advantageously, the silver-plated conductor according to the invention has good adhesion at the adhesion test which consists in winding the conductor around itself 5 to 6 times and then examining it under binocular observation at a magnification of ×10. It is considered that the adhesion is good only if no crack or detachment on the silver coating is detected.

The present invention in addition relates to an electromagnetic shielding layer (which is braided or helical) comprising at least one silver-plated strand according to the invention, advantageously all the strands of which are according to the invention, in particular intended for an electric cable.

Advantageously, the shielding layer according to the invention is obtained by helical assembly (or wrapping) of the silver-plated strands according to the invention.

The present invention in addition relates to an electric wire (or SPC electric wire) comprising a silver-plated conductor according to the invention. The electric wire further comprises an insulation layer. The insulating material used for manufacturing the insulation layer is a dielectric material, that is to say which does not conduct electricity. The main function of the dielectric is to maintain the electrical insulation performance between the main conductor of a cable and the conductive elements (at earth potential) for a defined period of time and in a defined environment.

Advantageously, the materials of the insulation layer are all qualified by standard ESCC3901 (May 2013). Advantageously, the insulating layer of the electric wire according to the invention comprises polytetrafluoroethylene (PTFE), ethylene tetrafluoroethylene (ETFE) and/or polyimide, in particular polyimide and/or PTFE, said layer being advantageously produced by extrusion or by taping, such as by extrusion for PTFE and ETFE or by taping for PTFE and polyimide in the form of a tape. The PTFE can also be sintered in order to give it optimized mechanical, thermal and dielectric properties, for example by passage in the oven at a temperature comprised between 380° C. and 475° C. The insulation layer is advantageously obtained by taping and may for example consist of one or more tapes, in particular:
1 polyimide tape produced for example at 150° C. or;
2 polyimide tapes, produced for example at 150° C. with a minimum overlap of 51% or;
3 tapes, such as a first PTFE tape in particular 56 μm thick, followed by a second polyimide tape in particular 25 μm thick, then a third PTFE tape in particular 50 μm thick, all with for example an overlap of 50%.

Advantageously, the electric wire according to the invention further comprises a finish layer on the insulation layer, based on polyimide, in particular in order to provide the wires with complementary functions, for example coloring. The implementation of this finish layer is generally carried out from a liquid polyimide using one or more passages, in particular 3, in an oven of 250° C. to 500° C. depending on the need.

Electric wires according to the invention are for example illustrated in FIGS. 2, 3 and 4.

Thus in FIG. 2 a conductor according to the invention (1), of the SPC 26-19×0.102C type, where 26 designates the AWG26, 19×0.102C the construction of 19 SPC strands according to the invention with a diameter of 0.102 mm concentrically, is covered by two successive polyimide tapes (2,3) produced at a temperature of 150° C. and with a minimum overlap of 51%. A finish polyimide layer (4, 5, 6) is applied by passing the taped wire 3 times in a polyimide-based liquid and then in an oven at 250° C. The wire thus produced has, on average, a diameter of 0.80 mm and a linear mass of 2.00 g/m.

In FIG. 3, a conductor according to the invention (1), of the SPC 22-19×0.160C type, where 22 designates the AWG22, 19×0.160C the construction of 19 SPC strands according to the Invention with a diameter of 0.160 mm concentrically, is covered with a polyimide tape (2) produced at a temperature of 150° C. A finish polyimide layer (3, 4, 5) is applied by passing the taped wire 3 times in a polyimide-based liquid and then in an oven at 250° C. The wire thus produced has, on average, a diameter of 1 mm and a linear mass of 4.15 g/m.

In FIG. 4 a conductor according to the invention (1), of the SPC 22-19×0.160C type, where 22 designates the AWG22, 19×0.160C the construction of 19 SPC strands according to the invention with a diameter of 0.160 mm concentrically, is covered successively by 3 tapes (2,3,4), namely a first tape (2) In PTFE 56 μm thick, followed by a second polyimide tape (3) 25 μm thick, then a third PTFE tape (4) 50 μm thick, all with 50% overlap. In practice, in order to property sinter the PTFE, two separate taping operations are carried out, each followed by a passage in an oven at 475° C. The wire thus produced has, on average, a diameter of 1.21 mm and a linear mass of 5.45 g/m.

Advantageously, the conductor of the electric wire (or SPC electric wire) according to the invention does not have any defect or only minor defects in the A&B test according to standard ECSS-Q-ST-70-20C (July 2008), in particular it has the code 0, 1, 2 or 3, more particularly the code 1 or 2, even more particularly the code 1, in the A&B test according to standard ECSS-Q-ST-70-20C.

Advantageously, the conductor of the electric wire according to the invention does not have any defect in the polysulfide test according to standard ISO 10308 (January 2006), in particular in the more severe polysulfide test in which the quenching time of the insulation stripped conductor in the sodium polysulfide solution was lengthened to 20 minutes.

The electric wire according to the invention can have a diameter comprised between 0.4 mm and 3.0 mm, advantageously between 0.5 and 1.5 mm.

The electric wire according to the invention is therefore advantageously obtained by taping or extruding dielectric on the silver-plated conductor according to the invention, followed by an optional application of a finish layer.

Thus, the process for manufacturing the electric wire according to the invention may comprise the following successive steps:
a—electrolytically depositing silver on a copper or copper alloy blank wire, said electrolytic deposition being performed at a pulsating current with reversal in a silver-plating bath comprising from 40 to 70 g/l of silver cyanide and from 90 g/l to 150 g/l of potassium cyanide, the electrolytic conditions being as described above;
b—drawing the silver-plated copper or copper alloy blank wire obtained in step a);
c—stranding (or assembling) the silver-plated strands obtained in step b);
d—taping or extruding the dielectric on the conductor obtained in step c), followed by an optional application of a finish layer.

The present invention further relates to an electric cable (or SPC electric cable) comprising at least one electric wire according to the invention, advantageously all the electric wires of which are according to the invention.

In particular, the electric cable according to the invention comprises a shielding layer, in particular a metal shielding layer, and a sheath.

The shielding layer helps to deal with problems caused by electromagnetic interference. There is a wide variety of shielding layer designs and configurations. This layer can in particular be braided, rolled up in the form of sheets, a combination of sheets and braiding or in helical form.

Advantageously, the shielding layer of the electrical cable according to the invention is constituted by the assembly of shielding strands according to the invention, in particular in helical or braided form. It is therefore advantageously the shielding layer according to the invention.

Advantageously, the sheath comprises polytetrafluoroethylene, ethylene tetrafluoroethylene, perfluoroalkoxy and/or polyimide, in particular perfluoroalkoxy, polyimide and/or PTFE, said sheath being advantageously produced by extrusion or by taping, such as by extrusion for perfluoroalkoxy, PTFE and ETFE or by taping for PTFE and polyimide in tape form. The PTFE can also be sintered in order to give it optimized mechanical, thermal and dielectric properties, for example by passage in the oven at a temperature comprised between 380° C. and 475° C. The sheath is advantageously obtained by taping and can for example consist of one or more tapes, in particular 2 tapes, such as a first polyimide tape then a second PTFE tape, all with for example an overlap of 25%. It can also be advantageously obtained by extrusion of PFA.

An electric cable according to the invention is for example illustrated in FIGS. 5 and 6.

Thus in FIG. 5, a subset of 4 electric wires according to the invention, each of them consisting of a conductor according to the invention (1) of the SPC 22-19×0.160C type and a polyimide tape (2, 3), is covered by a helical shielding layer of silver-plated strands according to the invention of the SPC36-01×0.127 type (5), in turn covered by a polyimide tape (6) with 25% overlap and a PTFE tape (7) also with 25% overlap, followed by a passage in an oven at 380° C. in order to sinter the PTFE tape. The cable thus manufactured has, on average, a diameter of 3.10 mm and a linear mass of 26.0 g/m.

Thus in FIG. 6, a subset of 2 electric wires according to the invention (1), each of them consisting of a conductor according to the invention of the SPC 22-19×0.160C type insulated successively by 3 tapes, namely a first PTFE tape 56 μm thick, followed by a second polyimide tape 25 μm thick, then a third PTFE tape 50 μm thick, all with 50% overlap, is covered by an electromagnetic shielding layer (2) obtained by braiding silver-plated strands according to the invention of the SPC40-01×0.079 type, in turn covered by a PFA sheath (3) obtained by extrusion. The cable thus manufactured has, on average, a diameter of 3.27 mm and a linear mass of 21.1 g/m.

Advantageously, the conductor of the electric cable (or SPC electric cable) according to the invention does not have any defect or only minor defects in the A&B test according to standard ECSS-Q-ST-70-20C (July 2008), in particular it has the code 0, 1, 2 or 3, more particularly the code 2 or 3, in the A&B test according to standard ECSS-Q-ST-70-20C.

Advantageously, the conductor of the electric cable according to the invention does not have any defect in the polysulfide test according to standard ISO 10308 (January 2006), in particular in the more severe polysulfide test in which the quenching time of the insulation stripped conductor in the sodium polysulfide solution was lengthened to 20 minutes.

The electric cable according to the invention can have a diameter comprised between 1.00 mm and 10.0 mm, advantageously between 2.0 mm and 5.0 mm, more advantageously between 0.5 mm and 4 mm, in particular between 0.5 mm and 1.5 mm.

The electric cable (or SPC electric cable) according to the invention is therefore advantageously obtained by a process comprising the following successive steps:
assembling several electric wires according to the invention so as to obtain a subset;
assembling silver-plated strands according to the invention on the subset so as to obtain a shielded subset (in particular a shielding layer on the subset)
sheathing the shielded subset.

Thus, the process for manufacturing the electric cable according to the Invention may comprise the following successive steps:
a—electrolytically depositing silver on a copper or copper alloy blank wire, said electrolytic deposition being performed at a pulsating current with reversal in a silver-plating bath comprising from 40 to 70 g/l of silver cyanide and from 90 g/l to 150 g/l of potassium cyanide, the electrolytic conditions being as described above;
b—drawing the silver-plated copper or copper alloy blank wire obtained in step a);
c—stranding (or assembling) the silver-plated strands obtained in step b);
d—taping or extruding the dielectric on the conductor obtained in step c), followed by an optional application of a finish layer;
e—assembling several electric wires obtained in step d);
f—assembling silver-plated strands obtained in step b) on the subset obtained in step e);
g—sheathing the shielded subset obtained in step f).

The present invention finally relates to the use of the electric wire according to the invention or of the electric cable according to the invention in the field of aerospace.

The present invention will be better understood upon reading the description of the figures and the examples which follow, which are given by way of non-limiting indication.

### BRIEF DESCRIPTION OF THE DRAWINGS

FIG. 1 schematically shows the PCR mode (electroplating at PCR) according to the invention

FIG. 2 shows an example of an electric wire construction diagram according to the invention according to standard ESCC3901-001-24 (May 2013) comprising a conductor according to the invention (1) of the SPC 26-19×0.102C type, two polyimide tapes (2,3) and a finish layer (4,5,6).

FIG. 3 shows an example of an electric wire construction diagram according to the invention according to standard ESCC3901-001-24 (May 2013) comprising a conductor according to the invention (1) of the SPC 22-19×0.160C type, a polyimide tape (2) and a finish layer (3,4,5).

FIG. 4 shows an example of an electric wire construction diagram according to the invention according to standard ESCC3901-018-06 (May 2013) comprising a conductor according to the invention (1) of the SPC 22-19×0.16C type, two PTFE tapes (2,4) and a polyimide tape (3).

FIG. 5 shows an example of an electric cable construction diagram according to the invention according to standard ESCC3901-002-70 (May 2013) comprising a subset of 4 electric wires according to the invention each of them consisting of a conductor according to the invention (1) of the SPC 22-19×0.160C type and a polyimide tape (2, 3), the subset being covered by a helical shielding layer of silver-plated strands according to the invention of the SPC36-01×0.127 type (5), in turn covered with a polyimide tape (6) and a PTFE tape (7).

FIG. 6 shows an example of an electric cable construction diagram according to the invention according to standard ESCC3901-018-53 (May 2013) comprising a subset of 2 electric wires according to the invention (1) each of them consisting of a conductor according to the invention of the SPC 22-19×0.160C type insulated successively by 3 tapes, namely a first PTFE tape 56 μm thick, followed by a second polyimide tape 25 μm thick, then a third PTFE tape 50 μm thick, all with 50% overlap, the subset being covered by an electromagnetic shielding layer (2) obtained by braiding silver-plated strands according to the invention of the SPC40-01×0.079 type, in turn covered by a PFA sheath (3) obtained by extrusion.

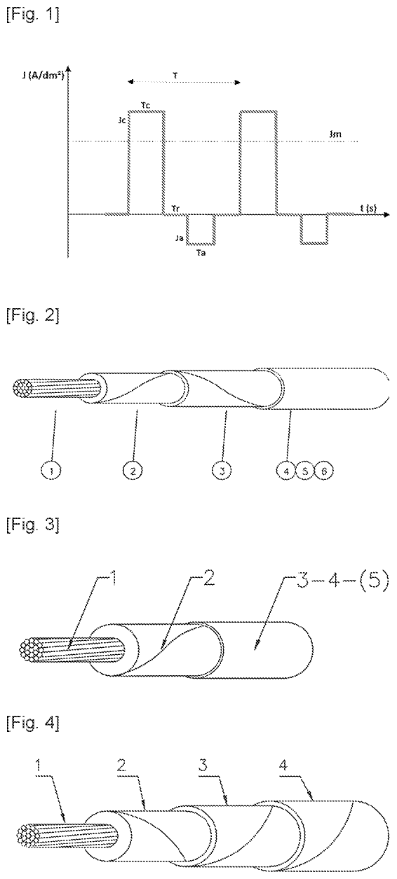

### EXAMPLES

### Examples 1 and 2: SPC Conductors According to the Invention

The silver-plating at PCR was carried out in an aqueous electrolytic bath whose composition is potassium cyanide KCN at 100 g/l, silver cyanide AgCN at 45 g/l and brightening additive from 10 to 30 ml/l using a Harlor PE86CB-20-10-50S generator capable of modulating electrical pulses in a wide range of operating parameters. A copper wire with a diameter of 1.2 mm is taken as a substrate in the tests (blank wire).

A more severe polysulfide test than that according to standard ISO 10308 was implemented on the SPC conductor obtained: the conductor whose surface is coated with a metal layer was soaked in a sodium polysulfide solution for 20 minutes, then it was rinsed and dried. A binocular examination is then carried out with magnification of ×10. It is considered that the test is OK when no point of corrosion on the conductor is observed.

An adhesion test as an evaluation criterion was also implemented on the obtained silver blank wire. Said test consists in winding the silver-plated copper wire around itself 5 to 6 times and then examining it under binocular observation at a magnification of ×10. It is considered that the adhesion is good only if no crack or detachment on the coating is detected.

The performance of the SPC conductor obtained in the A&B test according to standard ESCC 3901 was also evaluated.

An optical examination is also carried out. Thus, under a binocular (Motic SMZ-171) at a magnification of ×50, the appearance of the conductor is observed: brightness, homogeneity, absence of large grains. In this case, it is indicated as OK.

The thickness of silver on the SPC conductor obtained is measured by the X-ray fluorescence process on an apparatus of the Fischerscope XULM type.

The electrolytic deposition conditions and the test results are collected in Table 2 below.

TABLE 2

| | | |
|---|---|---|
| Examples | 1 | 2 |

| | | | |
|---|---|---|---|
| Jm | A/dm² | 1.78 | 1.78 |
| f | Hz | 1.54 | 0.8 |
| Q | % | 50 | 62 |
| Tc | ms | 325 | 738 |
| Ta | ms | 325 | 462 |
| Jc | A/dm² | 5 | 5 |
| Ja | A/dm² | 1.44 | 3.36 |
| T | s | 0.7 | 1.2 |
| Adhesion | | OK | OK |
| Thickness Ag | μm | 1.14 | 1.2 |
| Examination | Optical | OK | OK |
| polysulfide | 20 mins | OK | OK |
| A&B | Code | 1 | 2 |
| Number of samples | number | 3 | 2 |

The results obtained here allowed to estimate that for a silver-plating bath and the ranges of the PCR parameters as described above, a relatively satisfactory silver deposition performance is obtained in the Polysulfide test and in the A&B test.

### Examples 3 and 4: SPC Conductors According to the Invention with High-Speed Silver-Plating Bath

Based on the work of the 2 previous examples and in order to adopt a silver-plating process on an industrial scale, taking an average density Jm of 1.78 A/dm², silver-plating tests are carried out at PCR in a silver-plating bath called high-speed silver-plating bath, the composition of which is potassium cyanide KCN at 130 g/l, silver cyanide AgCN at 60 g/l and traces of additives (a brightening additive of 10 to 30 ml/l).

The same tests as in the previous example, carried out under the same conditions, were implemented. The electrolytic deposition conditions and the test results are collected in Table 3 below.

TABLE 3

| | | |
|---|---|---|
| Examples | 3 | 4 |

| | | | |
|---|---|---|---|
| Jm | A/dm² | 1.78 | 1.78 |
| F | Hz | 1 | 1 |
| Q | % | 60 | 55 |
| Tc | ms | 600 | 550 |
| Ta | ms | 400 | 450 |
| Jc | A/dm² | 5 | 5 |
| Ja | A/dm² | 3.05 | 2.16 |
| T | s | 1 | 1 |
| Adhesion | | OK | OK |
| Thickness Ag | μm | 1.20 | 1.15 |
| Examination | Optical | OK | OK |
| polysulfide | 20 min | OK | OK |
| A&B | Code | 2 | 1 |
| Number of samples | number | 2 | 2 |

The results clearly confirm the feasibility of silver-plating at PCR in a faster silver-plating bath.

### Example 5: Electric Wire According to the Invention

A silver-plating test at PCR on an industrial scale using a reel to reel type silver-plating line was implemented. In this case, 5 copper wires with a diameter of 0.254 mm are silver-plated simultaneously in a high-speed silver-plating bath similar to that of Examples 3 and 4 above with the operating parameters in PCR which are given in Table 4 below.

TABLE 4

| Examples | | 5 |
|---|---|---|
| Jm | A/dm² | 5 |
| f | Hz | 1 |
| Q | % | 65 |
| Tc | ms | 650 |
| Ta | ms | 350 |
| Jc | A/dm² | 7 |
| Ja | A/dm² | 1.28 |
| T | ms | 1000 |

It should be noted that the actual silver-plating conditions here are not quite identical to those in the laboratory in Examples 3 and 4 above, because the silver-plating line used as industrial equipment has many advantages: accepting in particular a greater electrolytic density and resulting in a more homogeneous coating in general.

These silver-plated copper wires are then used to make an SPC22-19×0.16C conductor. More specifically, they are first reduced in diameter by a drawing step b) according to the invention (drawing from 0.254 mm to 0.16 mm, that is to say a reduction rate of 63%, using 7 drawing dies), then assembled by a stranding step c) according to the invention (19 strands of 0.16 mm concentrically of AWG 22). At each step, the adhesion test, the appearance examination and the polysulfide test are carried out with conclusive results.

From this conductor, an SPC electric wire according to standard ESCC3901-018-06 (May 2013), the construction of which is schematically shown in FIG. 4 below, is manufactured.

According to this standard ESCC3901-018-06, the conductor must be insulated successively by 3 tapes, namely a first PTFE tape 56 μm thick, followed by a second polyimide tape 25 μm thick, then a third PTFE tape 50 μm thick, all with 50% overlap. In practice, in order to properly sinter the PTFE, two separate taping operations are carried out (taping I for the first PTFE tape and taping II for the polyimide tape followed by the second PTFE tape) each followed by a passage in an oven at 475° C. The sintering of the PTFE is essential here, allowing to give the PTFE the optimized mechanical, thermal and dielectric properties for the electric wire to comply with said standard.

As mentioned previously, thermal impact is generally considered to be the primary cause of degraded performance in the A&B test of an SPC electric wire. The choice of an ESCC3901-018-06 wire seems relevant in order to evaluate the improvement that can be brought by silver-plating in PCR, because the manufacture of this wire, involving one of the highest sintering temperatures, is the most critical among all SPC electric wires of standard ESCC3901.

A set of manufacturing data for the SPC22-19×0.160C conductor and the ESCC3901-018-06 wire, along with the silver thicknesses and A&B test codes measured at each manufacturing step, is given in Table 5 below. The electric wire obtained has a diameter of 1.21 mm and a linear mass of 5.45 g/m.

TABLE 5

| Manufacturing | Conductor/ | Silver | A&B test |
|---|---|---|---|
| step | wire ref | thickness in μm | code |
| a-Silver-plating | SPC30-01x0.254 | 1.67 | 0 |
| b-Drawing | SPC34-01x0.160 | 1.28 | 0 |
| c-Stranding | SPC22-19x0.160C | 1.28 | 1 |
| d-Taping I | | 1.28 | 1 |
| d-Taping II | ESCC3901-018-06 | 1.28 | 1 |

The results obtained in the A&B test on this electric wire according to the invention made of an SPC conductor whose silver-plating is made of PCR are particularly good, whereas the thickness of silver here is only half that of a wire made conventionally at DC.

### Example 6: Electric Cable According to the Invention

In this example, one of the most sophisticated electric cables is selected, allowing better protection against electromagnetic interference. It is also the most severe case compared to the A&B test given the number of manufacturing steps involved.

In fact, electric cable means here a transmission line which comprises one or more twisted electric wires and then covered with a layer of electromagnetic shielding and then again with an insulating sheath, as shown in comparative Example 4 below. Said shielding layer is made by braiding a number of SPC strands, and said sheath by PFA (perfluoroalkoxy) extrusion. More specifically, a cable is made according to standard ESCC3901-018-53 (May 2013) and the following manufacturing steps are carried out:

### A. Silver-Plating on Blank Wire

First, an SPC wire 0.254 mm in diameter is produced on a silver-plating line other than that used in Example 5, called TS4, and whose silver-plating bath has the composition of that of Examples 3 and 4. The production is carried out at a running speed of 4.0 m/min and under the silver-plating conditions at PCR indicated in the following table 6.

TABLE 6

| Jm | f | Q | Jc | Ja | Tc | Ta |
|---|---|---|---|---|---|---|
| 9.6 A/dm² | 1.0 Hz | 65% | 10 A/dm² | 3.1 A/dm² | 0.65 s | 0.35 s |

The thickness of the silver layer on the wire is on average 3.66 μm.

### B. Drawing the Silver Wire

The SPC wire obtained is reduced by drawing to pass from the diameter of 0.254 mm to the diameter of 0.079 mm, that is to say a reduction rate of 31%, the thickness of silver being reduced on average to 1.14 μm. The SPC strand thus obtained is Intended to constitute electromagnetic shielding.

### C. Assembling the 2 Electric Wires

2 electric wires produced in Example 5 corresponding to standard ESCC3901-018-06 (May 2013) are assembled by twisting them to form a pair which corresponds to standard ESCC3901-018-15 (May 2013).

### D. Shielding by Braiding

The pair formed then undergoes electromagnetic shielding by braiding.

### E. Sheathing by Extruding the Shielded Pair

PFA sheathing is carried out by extrusion on the shielded pair and an SPC electric cable is obtained in accordance with standard ESCC3901-018-53 (May 2013), shown schematically in FIG. 6.

The A&B test is carried out at each step of the operation both on the central conductor of the electric wires and on the braided shield of the electric cable. The results obtained are summarized in Tables 7 and 8 below.

TABLE 7
Summary of A&B results on the 2 central conductors

| | | Silver | A&B test |
|---|---|---|---|
| Manufacturing step | Ref. wire/cable | thickness in μm | codes |
| SPC wire - Example 5 | ESCC3901-18-06 | 1.28 | 1 |
| Step C - Assembly | ESCC3901-18-15 | 1.28 | 1 |
| Step D - Shielding | ESCC3901-18-53 | 1.28 | 1 |
| Step E - Sheathing | ESCC3901-18-53 | 1.28 | 1 |

TABLE 8
Summary of A&B results on electromagnetic shields

| | Conductor/wire/ | Silver | |
|---|---|---|---|
| Manufacturing step | cable ref | thickness in μm | A&B test codes |
| Step A - Silver- | SPC30-01x0.254 | 3.66 | 0 |
| plating | | | |
| Step B - Drawing | SPC40-01x0.079 | 1.14 | 0 |
| Step D - Shielding | ESCC3901-18-53 | 1.14 | 1 |
| Step E - Sheathing | ESCC3901-18-53 | 1.14 | 1 |

This example clearly demonstrates that one of the most elaborate electric cables according to standard ESCC3901, in this case ESCC3901-018-53, manufactured according to the process described here, in particular using the PCR silver-plating technique according to the invention, satisfies the technical requirements of standard ESCC3901, in particular the A&B test, by having as the minimum silver thickness 1.0 μm instead of 2.0 μm.

### Comparative Example 1: Electric Wire Whose Silver-Plating is Carried Out at Direct Current (DC) with a Thickness of Silver<2 μm

An electric wire, made according to standard ESCC3901-001-24, which is commonly used in space cabling is chosen as a basis of comparison. The corresponding SPC conductor is therefore of the SPC 26-19×0.102C type, where 26 designates the AWG26, 19×0.102C the construction of 19 SPC strands with a diameter of 0.102 mm concentrically, each strand being coated with an average thickness of silver of 1.35 μm measured by the X-ray fluorescence process on a Fischerscope XULM type apparatus.

The silver-plating at DC was carried out under an electrolytic current density of 1 A/dm² in an aqueous electrolytic bath whose composition is potassium cyanide KCN at 100 g/l, brightening additive from 10 to 30 ml/l and silver cyanide AgCN at 45 g/l.

Such a conductor is used to produce by taping according to the manufacturing step E4 an SPC electric wire according to standard ESCC3901-001-24.

More specifically, the manufacturing step E4 here comprises 2 sub-steps. The first is the taping of two successive polyimide tapes carried out at a temperature of 150° C. and with a minimum overlap of 51%. The second consists in depositing a polyimide finish layer by passing the taped wire 3 times in a polyimide-based liquid and then in an oven at 250° C. The wire thus produced has, on average, a diameter of 0.80 mm and a linear mass of 2.00 g/m.

The construction of the SPC wire can be schematically shown in FIG. 2. The SPC conductor and the SPC electric wire are tested in the A&B test respectively at the end of step E3 (stranding) and step E4 (taping), and receive respectively as a result the codes of 1 and 4, as shown in Table 9 below.

TABLE 9

| | | Silver | |
|---|---|---|---|
| Manufacturing step | Construction | thickness | A&B test code |
| E3-Stranding | SPC26-19x0.102C | 1.35 μm | 1 |
| (conductor) | | | |
| E4-Taping (wire) | ESCC3901-001-24 | 1.35 μm | 4 |

It can be concluded that although the SPC conductor obtained has good performance in the A&B test, the SPC electric wire cannot be considered acceptable according to standard ESCC3901. The degradation in resistance to the A&B test is certainly related to the manufacturing step E4 which Involves a combination of mechanical stresses coming from the taping operation and thermal stresses due to successive passages in ovens.

### Comparative Examples 2-4: Electric Wires and Cables Whose Silver-Plating is Carried Out at Direct Current (DC) with a Minimum Thickness of Silver of 2 μm

SPC22-19×0.160 conductors and an SPC36-01×0.127 strand are manufactured using the same silver-plating at DC as in comparative Example 1 but with a silver coating with a minimum thickness of 2 μm in accordance with standard ESCC3901. The silver-plating at DC, as well as the measurement of silver thickness, are carried out under the same conditions as those of comparative Example I. The SPC22-19×0.160C conductors, namely of AWG22 and made up of 19 SPC strands 0.16 mm in diameter, are used to make electric wires according to standards ESCC3901-001-26 (comparative Example 2), ESCC3901-002-58 (comparative Example 3) and a ESCC3901-002-70 cable (comparative Example 4), while the SPC36-01×0.127 strand of AWG36 and 0.127 mm in diameter allows to form a helical shield for the following ESCC3901-002-70 cable.

The production of the ESCC3901-001-26 wire (comparative Example 2) as illustrated in FIG. 2, is obtained by taping a polyimide tape followed by the deposition of a polyimide finish layer. The SPC electric wire thus manufactured has, on average, a diameter of 1.10 mm and a linear mass of 4.20 g/m.

The production of the SPC electric wire ESCC3901-002-58 (comparative Example 3) as it is illustrated in FIG. 3, is obtained by taping a single polyimide tape at 150° C., followed by the deposition of a polyimide finish layer, then the passage in an oven at 250° C. in 2 or 3 passages. The wire thus produced has, on average, a diameter of 1.00 mm and a linear mass of 4.15 g/m.

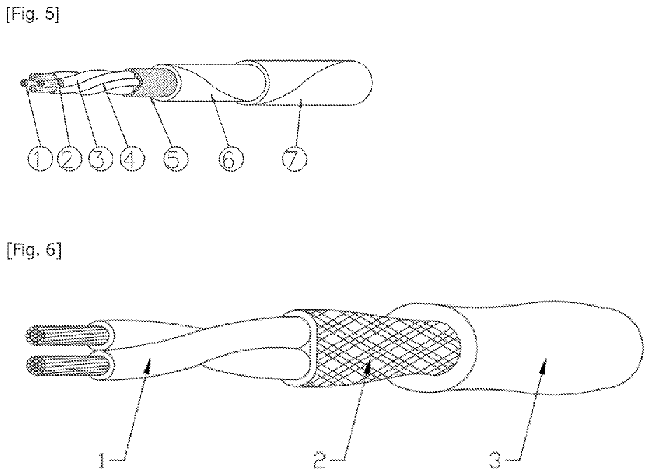

The production of the ESCC3901-002-70 SPC electric cable (comparative ex 4) as it is illustrated in FIG. 5, comprises 3 operations. The first consists in forming by stranding a subset of 4 ESCC9301-002-58 electric wires, the second consists in covering the subset with a helical shielding layer of SPC36-01×0.127 strands, and the third consists in taping above the shielded subset a polyimide tape with 25% overlap and another PTFE tape also with 25% overlap, followed by a passage in an oven at 380° C. in order to sinter the PTFE tape. The cable thus manufactured has, on average, a diameter of 3.10 mm and a linear mass of 26.0 g/m.

The A&B test is then carried out at the end of stranding and at the end of taping on the conductor of the wire of the comparative Example 2, at the end of drawing, stranding and taping on the conductor of the wire of the comparative Example 3, at the end of drawing E2 and at the end of sheathing E7 the cable of the comparative Example 4. The test codes, as well as the silver thicknesses of the conductor, are summarized in table 10 below.

TABLE 10

| | | | | A&B |
|---|---|---|---|---|
| Comparative | Manufacturing | | Silver | test |
| Examples | step | Construction | thickness | code |
| 2 | E3-Stranding | SPC22-19x0.160 | 2.45 μm | 0 |
| 2 | E4-Taping | ESCC3901-001-26 | 2.45 μm | 3 |
| 3 | E2-Drawing | SPC3401x0.16 | 2.45 μm | 1 |
| 3 | E3-Stranding | SPC2219x0.16C | 2.45 μm | 1 |
| 3 | E4-Taping | ESCC3901-002-58 | 2.45 μm | 2 |
| 4 | E2-Drawing | SPC36-01x0.127 | 2.58 μm | 1 |
| 4 | E7-Sheathing | ESCC3901-002-70 | 2.58 μm | 4 |

It can be seen that, in fact, a thickness of silver of more than 2 μm allows to improve the resistance to the A&B test both at the end of the manufacture of the conductor and at the end of the manufacture of the electric wire.

The results also seem to show that despite a thickness of silver beyond 2 μm on the SPC36-01×0.127 strands, once the wrapping has been done, the resistance to the A&B test is greatly degraded. In other words, the wrapping, taping and sintering operations have a strong impact on the A&B test resistance of the silver coating, thus justifying the minimum silver thickness of 2 μm imposed by standard ESCC3901.

### Comparative Examples 5-11: Conductors Whose Silver-Plating is Made of PCR but with Different Electrolytic Conditions

Conductors were manufactured under the same conditions as those of Examples 1 and 2 with the exception of the electrolytic conditions which are collected in Table 8 below.

The same tests as those indicated in Examples 1 and 2 were carried out on the silver-plated conductors obtained and the results are indicated in Table 11 below.

TABLE 11

| Comparative | | | | | | | | |
|---|---|---|---|---|---|---|---|---|
| Examples | | 5 | 6 | 7 | 8 | 9 | 10 | 11 |
| Jm | A/dm² | 1.78 | 1.78 | 3 | 3 | 3 | 1.78 | 1.78 |
| f | Hz | 1.54 | 0.83 | 2,5 | 2.5 | 1,43 | 0.8 | 1.5 |
| Q | % | 25 | 90 | 50 | 62 | 62 | 70 | 45 |
| Tc | ms | 163 | 1080 | 200 | 246 | 430 | 840 | 293 |
| Ta | ms | 488 | 120 | 200 | 154 | 270 | 360 | 357 |
| Jc | A/dm² | 8.0 | 3.0 | 8.0 | 5.0 | 5.0 | 5 | 8 |
| Ja | A/dm² | 0.34 | 9.20 | 2.00 | 0.20 | 0.19 | 5.73 | 3.26 |
| T | S | 0.7 | 1.2 | 0.4 | 0,4 | 0.7 | 1.2 | 0.7 |
| Adhesion | | OK | OK | OK | NOK | NOK | OK | OK |
| Thickness Ag | μm | 1.20 | 0.92 | 0.94 | 1.4 | 1.54 | 1.05 | 1.04 |
| Examination | Optical | NOK | OK | NOK | NOK | NOK | OK | NOK |
| polysulfide | 20 min | NOK | NOK | NOK | NOK | NOK | AVERAGE | AVERAGE |
| A&B | Code | | | | | | 3 | |
| Number of | number | 2 | 2 | 3 | 2 | 3 | 1 | 1 |
| samples | | | | | | | | |

The results obtained demonstrate that the electrolytic conditions are important to obtain a silver-plated conductor conforming to the standards.

### Comparative Examples 12-13: Conductors Whose Silver-Plating is Made of PCR with a High-Speed Silver-Plating Bath, but with Different Electrolytic Conditions

Conductors were manufactured under the same conditions as those of Examples 3 and 4 with the exception of the electrolytic conditions which are collected in Table 9 below.

The same tests as those indicated in Examples 3 and 4 were carried out on the silver-plated conductors obtained and the results are indicated in Table 12 below.

TABLE 12

| | | |
|---|---|---|
| Comparative examples | 12 | 13 |

| | | | |
|---|---|---|---|
| Jm | A/dm² | 1.78 | 1.78 |
| f | Hz | 1 | 2 |
| Q | % | 70 | 50 |
| Tc | ms | 700 | 250 |
| Ta | ms | 300 | 250 |
| Jc | A/dm² | 5 | 8 |
| Ja | A/dm² | 3.05 | 0.88 |
| T | s | 1 | 0.5 |
| Adhesion | | OK | OK |
| Thickness Ag | μm | 0.99 | 1.49 |
| Examination | Optical | OK | |
| polysulfide | 20 mins | average | average |
| A&B | Code | 4 | |
| Number of samples | number | 2 | 1 |

The results obtained show that the electrolytic conditions are important to obtain a silver-plated conductor conforming to the standards.

1. A process for manufacturing a silver-plated copper or copper alloy blank wire, having a silver layer thickness of 1.5 μm to 15 μm, comprising the step of electrolytically depositing silver on the copper or copper alloy blank wire, said electrolytic deposition being performed at a pulsating current with reversal in a silver-plating bath comprising from 40 to 70 g/l of silver cyanide and from 90 g/l to 150 g/l of potassium cyanide, the electrolytic conditions being as follows:
average current density Jm comprised between 1.5 A/dm² and 15 A/dm²;
pulse frequency f comprised between 0.8 Hz and 1.6 Hz;
duty cycle Q comprised between 50 and 80%;
current density of the cathode peak Jc comprised between 3 A/dm² and 11 A/dm²;
current density of the anode peak Ja comprised between 1 A/dm² and 5 A/dm²;
time of maintaining the cathodic pulse Tc comprised between 0.2 s and 0.8 s and
time of maintaining the anode pulse Ta comprised between 0.06 s and 0.5 s.

2. A silver-plated copper, or copper alloy blank wire, having a silver layer thickness of 1.5 μm to 15 μm, obtainable by the process according to claim 1.

3. A process for manufacturing a silver-plated copper, or copper alloy strand, having a silver layer thickness of 1 μm to 1.5 μm, comprising the step of drawing the silver-plated copper or copper alloy blank wire according to claim 2.

4. A silver-plated copper or copper alloy strand, having a silver layer thickness of 1 μm to 1.5 μm, obtainable by the process according to claim 3.

5. A silver-plated conductor comprising at least one silver-plated strand according to claim 4.

6. An electromagnetic shielding layer comprising at least one silver-plated strand according to claim 4.

7. An electric wire comprising a silver-plated conductor according to claim 5.

8. The electric wire according to claim 7, characterized in that its insulating layer comprises polytetrafluoroethylene, ethylene tetrafluoroethylene and/or polyimide.

9. An electric cable comprising at least one electric wire according to claim 7.

10. The electric cable according to claim 9, characterized in that its shielding layer is according to claim 6.

11. The electric cable according to claim 9, characterized in that its sheath comprises polytetrafluoroethylene, ethylene tetrafluoroethylene, perfluoroalkoxy and/or polyimide.

12-13. (canceled)
